(19) United States
(12) Patent Application Publication
(10) Pub. No.: US 2007/0268218 A1
(43) Pub. Date: Nov. 22, 2007

(54) ACTIVE MATRIX DISPLAY DEVICE

(76) Inventors: Seiichi Mizukoshi, Kanagawa (JP); Makoto Kohno, Kanagawa (JP); Kouichi Onomura, Yokohama-shi (JP)

Correspondence Address: Patent Legal Staff;Eastman Kodak Company, 343 State Street, Rochester, NY, 14650-2201, US

(21) Appl. No.: 11/744,242

(22) Filed: May 4, 2007

(30) Foreign Application Priority Data
May 16, 2006 (JP) 2006-137078

(51) Int. Cl. G09G 3/30

(52) U.S. Cl. 345/76

(57) ABSTRACT

An organic EL display device, including a display panel having pixels arranged in a matrix state, each pixel including an organic EL element and being provided with a driving thin film transistor that corresponds to each organic EL element, and which controls light emission therefrom; a driving power supply that supplies the display panel with a power supply voltage for driving each organic EL element; and voltage changing section for changing the power supply voltage supplied from the driving power supply to the display panel based on one or both of average characteristics of the driving thin film transistor and average characteristics of the organic EL element in the display panel.

### CROSS-REFERENCE TO RELATED APPLICATION

This application claims priority to Japanese Patent Application No. 2006-137078 filed May 16, 2006 which is incorporated herein by reference in its entirety.

### FIELD OF THE INVENTION

The present invention relates to an active matrix organic EL display device having pixels arranged in a matrix state, each pixel including an organic EL element and provided with a driving thin film transistor that corresponds to each organic EL element, and which controls light emission therefrom.

### BACKGROUND OF THE INVENTION

FIG. 1 shows a prior art pixel circuit for a single pixel in an active matrix organic EL display device.

The source of a driving TFT1, being a p-channel thin film transistor, is connected to a power source PVdd, and its drain is connected to the anode of an organic EL element 3. Further, the cathode of the organic EL element 3 is connected to a power source CV.

The source or the drain of a selective TFT2, an n-channel thin film transistor, is connected to the gate of the driving TFT1, and the drain or the source of the selective TFT2 is connected to a data line Data with the gate being connected to a gate line Gate. Moreover, a holding capacitor C is connected between gate and source (power source PVdd) of the driving TFT1.

In such a pixel circuit, the gate line Gate extending in horizontal directions is set to H level, the selective TFT2 is turned on, and data signals having voltage corresponding to display luminance are put on the data line (Data) extending in vertical directions in this state, and thus data signals are accumulated in the holding capacitor C. Thus, the driving TFT1 supplies drive current corresponding to the data signals to the organic EL element 3, and the organic EL element 3 emits light.

The light emission intensity of the organic EL element 3 and current flowing therein are in a substantially proportional relationship. Normally, voltage (Vth) that causes drain current to start flowing near the black level of an image is applied between gate-PVdd of the driving TFT1. Further, as amplitude of an image signal, an amplitude reaching a predetermined luminance near the white level is applied.

FIG. 2 shows a relationship between current CV (corresponding to luminance) flowing in the organic EL element 3 and the input data voltage (voltage of data line Data) of the driving TFT1. By determining the data signal so as to give Vth (threshold voltage) as a black level voltage and to give Vw as white level voltage, appropriate gradation control in the organic EL element 3 can be performed.

In other words, luminance when a pixel is driven at a certain voltage is different depending on Vth of the driving TFT1, with input voltage near the Vth corresponding to a data voltage when displaying black. Further, the inclination (μ) of V-I curve of the TFT may disperse in the same manner, and in this case, input amplitude to generate the same luminance is also different, as shown in FIG. 3.

When the Vth of the driving TFT1 in the display panel disperses, it usually causes uneven luminance. Further, in the case where process conditions or the like change for each manufacture lot, average values of Vth of the driving TFT1 in the display panels could vary for each lot, and in this case, it causes dispersion of luminance between the display panels (see U.S. Published Patent Application 2004-0150592 and WO 2005/101360).

### SUMMARY OF THE INVENTION

In accordance with the present invention there is provided in an organic EL display device, comprising:

a display panel having pixels arranged in a matrix state, each pixel including an organic EL element and being provided with a driving thin film transistor that corresponds to each organic EL element, and which controls light emission therefrom;

a driving power supply that supplies the display panel with a power supply voltage for driving each organic EL element; and voltage changing section for changing the power supply voltage supplied from the driving power supply to the display panel based on one or both of average characteristics of the driving thin film transistor and average characteristics of the organic EL element in the display panel.

### BRIEF DESCRIPTION OF THE DRAWINGS

FIG. 1 is a view showing a prior art a pixel circuit;

FIG. 2 is a view showing the relationship between data voltage and CV current;

FIG. 3 is a view showing the relationship between data voltage and CV current in two TFTs having different characteristics;

FIG. 4 is a view showing the minimum value of Vdamax when PVdd is fixed;

FIG. 5 is a view that explains another example showing the minimum value of Vdamax when PVdd is fixed;

FIG. 6 is a view showing the minimum value of Vdamax when PVdd is fixed by using specific values;

FIG. 7 is a view showing the minimum value of Vdamax when PVdd voltage is adjusted by each panel;

FIG. 8 is a view showing the minimum value of Vdamax when PVdd voltage is adjusted by each panel using specific values;

FIG. 9 is a view showing a display device according to an embodiment;

FIG. 10 is a view showing an external view of a display panel and a flexible cable; and

FIG. 11 is a view showing a constitution of a display device according to another embodiment.

### DESCRIPTION OF PREFERRED EMBODIMENTS

Herein, it is assumed that there is no dispersion of the TFTs of each pixel in a display panel, and only dispersion of TFT characteristics between display panels is considered.

To deal with the dispersion of Vth between the display panels, drive data voltage corresponding to black is usually adjusted for Vth of the display panel to eliminate black stand-out, flat dark area or the like. Further, amplitude Vp-p of a drive signal is also adjusted to allow white to have predetermined luminance. In this case, since Vth and the maximum value and the minimum value of dispersion of V-I curve need to be considered, it is necessary to design the output voltage of a driver IC that supplies the data voltage to the display panel (usually, it is D/A (digital/analog converter) output voltage) by allowing sufficient margin as described below.

First, from the maximum value of the dispersion of (Vp-p+Vth) and the minimum voltage value (Vdamin) that the D/A can output, positive side power supply voltage (PVdd) of the display panel is determined.

PVdd=(Vp-p+Vth)max+Vdamin [Expression 1]

Herein, (Vp-p+Vth)max is the maximum value of the dispersion of (Vp-p+Vth).

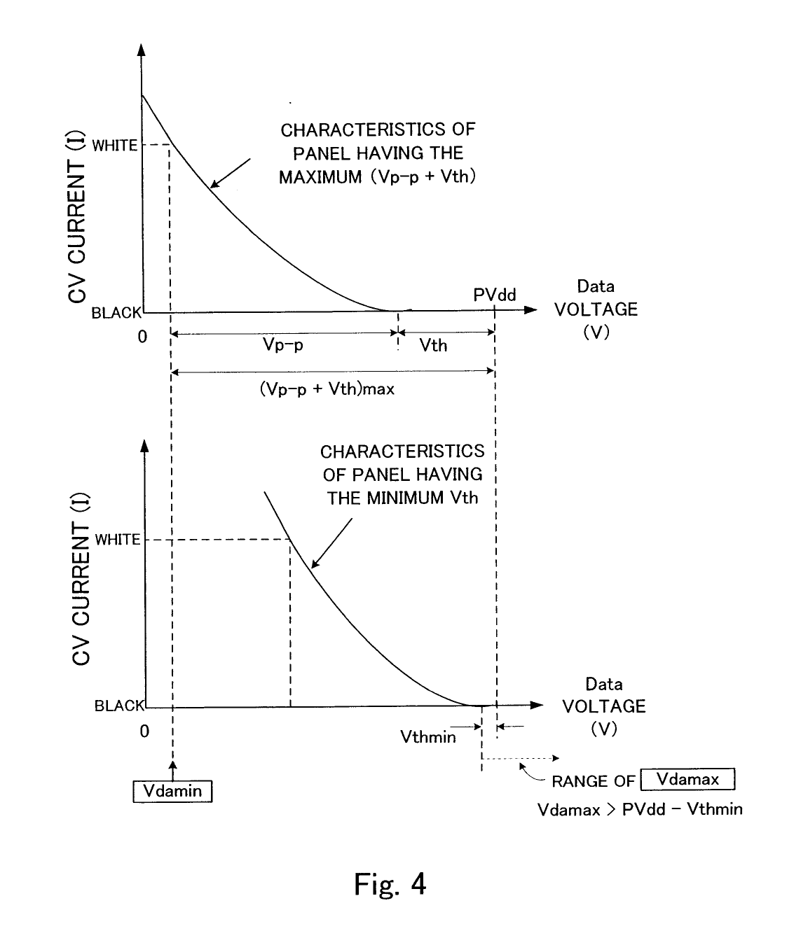

Next, since the highest black data voltage is required for a display panel having the minimum Vth, the maximum D/A output voltage (Vdamax) of the driver IC, which is required, is as follows assuming that the Vth is Vthmin (FIG. 4).

$$Vda max > PVdd - Vth min = ( Vp \text{-} p + Vth ) max + Vda min - Vth min \qquad [ Expression 2 ]$$

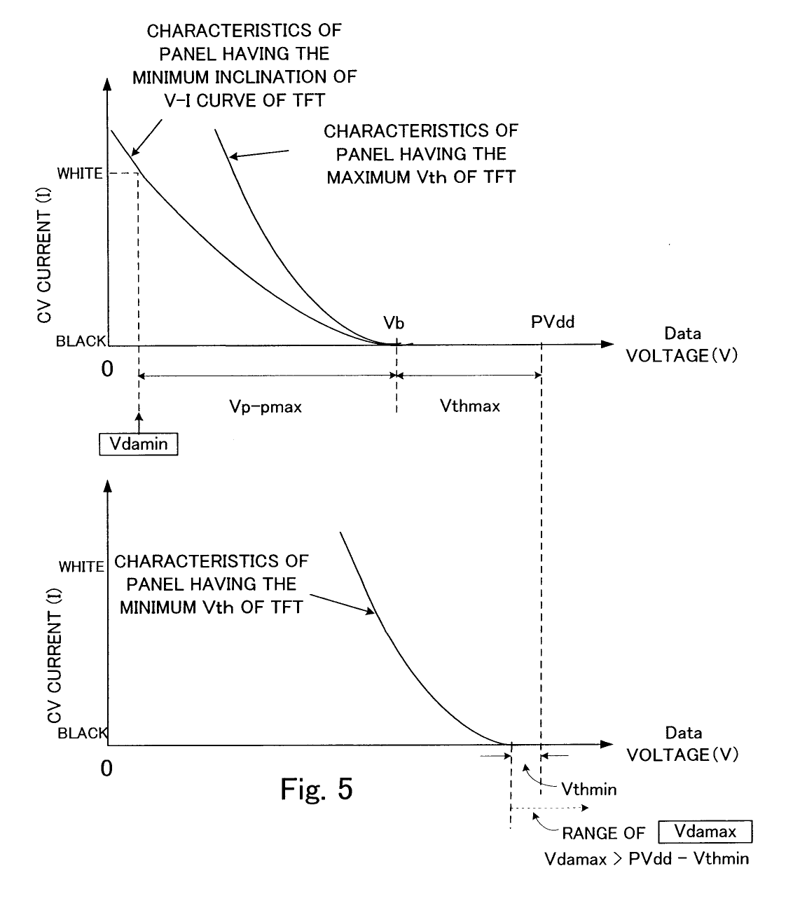

If the dispersion of Vp-p and Vth do not have correlation but are independent, a display panel having the maximum Vp-p and the maximum Vth could exist, and thus conditions become more strict, and the following holds (FIG. 5).

Vdamax>Vp-pmax+Vthmax+Vdamin−Vthmin [Expression 3]

### Herein, a TFT having Vp-pmax is a TFT having the minimum inclination (μ) of V-I curve.

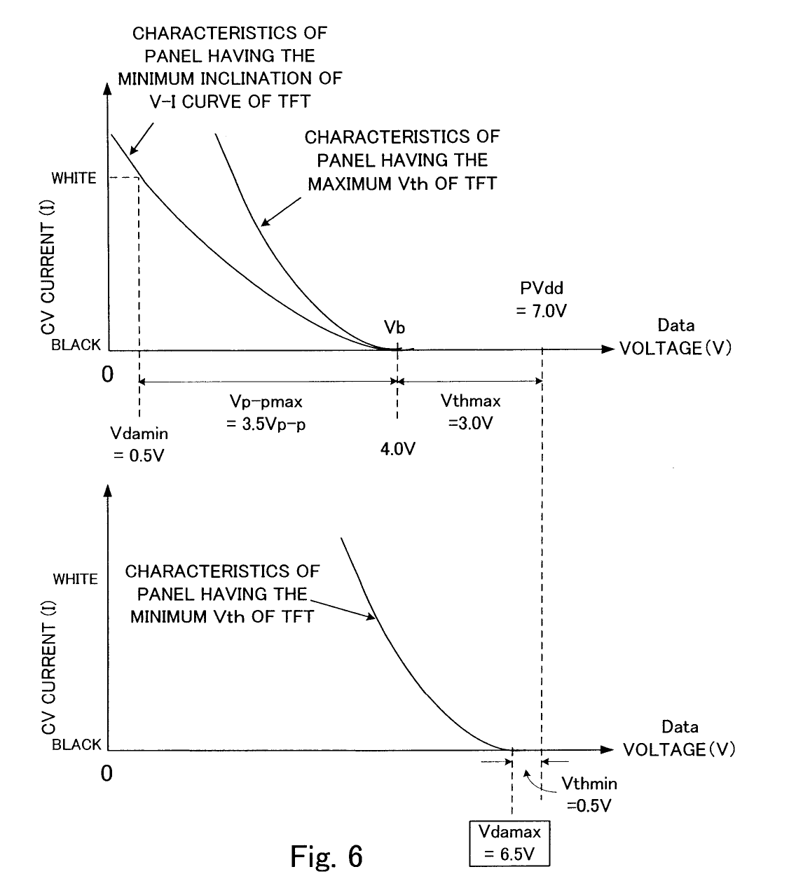

For example, as shown in FIG. 6, assuming that the minimum voltage (Vdamin) of D/A output is 0.5V and the maximum input signal amplitude required for a display panel having the minimum inclination of TFT curve is 3.5 Vp-p, the minimum voltage that can be set as black voltage (Vb) is 4.0V. Assuming that Vthmax and Vthmin are 3.0V and 0.5V respectively, PVdd needs to be set to 7.0V or higher in order to secure the Vb in a display panel having Vthmax. At this point, Vdamax requires 6.5V or higher, which is lower than the PVdd only by 0.5V, to make it possible to output Vb of the display panel having Vthmin.

As described, the threshold voltage Vth of the driving TFT and the dispersion of the inclination (μ) of V-I characteristics are considered, high voltage is required for the D/A output of the driver IC and the power supply voltage PVdd, and the power consumption of the display device increases. The D/A output voltage becomes a factor in determining the power supply voltage of the driver IC, and it is required to select a semiconductor process used in production corresponding to the voltage. A process using as low a withstand voltage as possible is advantageous from the point of view of cost and the like.

The present invention is characterized in that it has: a display panel having pixels arranged in a matrix state, each pixel including an organic EL element and being provided with a driving thin film transistor that corresponds to each organic EL element, and which controls light emission therefrom; a driving power supply that supplies the display panel with a power supply voltage for driving each organic EL element; and voltage changing section for changing the power supply voltage supplied from the driving power supply to the display panel based on one or both of average characteristics of the driving thin film transistor and average characteristics of the organic EL element in the display panel.

Further, it is preferable that the voltage changing section changes power supply voltage on the source side of the driving thin film transistor based on the average threshold voltage of the driving thin film transistor.

Further, it is preferable that the voltage changing section changes the voltage of the cathode side of the organic EL element based on necessary signal amplitude and the characteristics of the organic EL element.

Further, the invention has a memory that stores the set value of the power supply voltage to be supplied to the display panel, and it is preferable that the voltage changing section reads out the set value from the memory when turning the power source of the display device ON and applies power supply voltage corresponding to the read out set value to the display panel.

Further, the invention has measuring section for measuring the average threshold voltage of the driving thin film transistor, and it is preferable that the voltage changing section changes the power supply voltage based on the average threshold voltage measured by the measuring section.

Further, the measuring section includes current detecting section for detecting current flowing in the display panel, and it is preferable to apply black level displaying voltage to the gate of the thin film transistor, change the power supply voltage in that state by the voltage changing section, and measure the average threshold voltage based on the detected current in the current detecting section.

Further, the present invention is characterized in that it provides a display panel having pixels arranged in a matrix state, each pixel including an organic EL element and being provided with a driving thin film transistor that corresponds to each organic EL element, and which controls light emission therefrom, measures the value of the average threshold value voltage of the driving thin film transistor in the manufactured display panel, and sets power source voltage in the display panel based on the measured average threshold voltage value, necessary signal amplitude, and the characteristics of the organic EL element.

FIG. 9 shows the constitution of the organic EL display device according to the present invention. Various signals from a display drive section 10 are supplied to a display panel 40 via a flexible cable 20 and a driver IC 30.

The display drive section 10 is a section that outputs displaying image data in each application device, and outputs each RGB signal, dot clock showing the output timing of each dot of RGB signal, a horizontal synchronous signal showing the timing for 1 horizontal period, vertical synchronous signal showing the timing for 1 vertical period, and other drive signals required for driving the display panel. Further, the section has a micro controller 12 that performs power supply voltage control in this embodiment, and a DC-DC converter 14 that outputs power supply voltage to be supplied to the display panel 40 corresponding to the control signal from the micro controller 12.

Each signal from the display drive section 10 is supplied to the driver IC 30 via the flexible cable 20. It should be noted that a non-volatile memory 22 (described later), which is connected to a line connecting the micro controller 12 and the driver IC 30, is mounted on the flexible cable 20.

The driver IC 30 supplies data voltage to the display panel 40, and has a data latch 32, a D/A converter 34, and a gate driver 36 inside thereof The data latch 32 sequentially stores pixel data of each pixel for 1 row, which is input from the display drive section 10 via the flexible cable 20, and outputs digital data corresponding to each data line Data. The output from the data latch 32 is supplied to the D/A converter 34, and the D/A converter 34 converts the digital data of each pixel from the data latch 32 into analog data voltage, and supplies it to the data line Data corresponding to the display panel 40.

Further, the gate driver 36 sequentially activates the gate line Gate for 1 horizontal period based on the horizontal synchronous signal and the vertical synchronous signal.

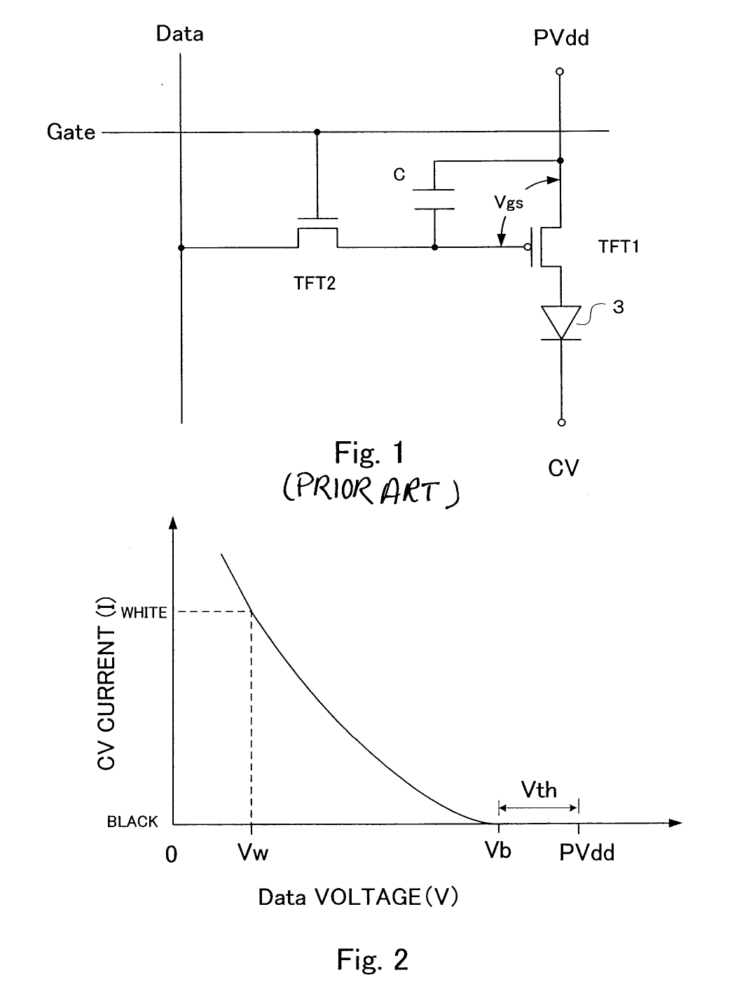

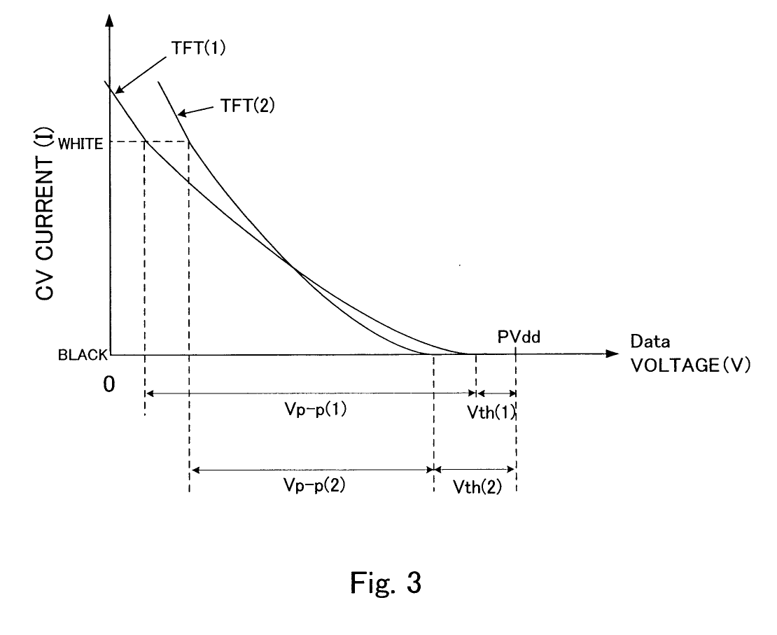

The display panel 40 has the pixel circuits as shown in FIG. 1 formed on a transparent substrate (glass substrate) in a matrix state, for example, with the data line Data provided corresponding to each column of pixels, and the gate line Gate is provided corresponding to each row. Further, a power source line is normally provided corresponding to each column, for example, this power source line becomes the power source PVdd, and furthermore, the cathode of the organic EL element 3 is commonly formed for all pixels, and the cathode becomes the power source CV. It should be noted that the TFTs are formed by using amorphous silicon and polysilicon formed on the substrate as an active layer.

In the state where data voltage for one row is supplied from the data latch 32 to the data line Data, the gate line Gate of an appropriate row is activated, and the data voltage of the data line Data is written in each corresponding pixel. Therefore, display based on the image data of the pixel is performed in each pixel, and it is performed for each pixel, so that display in response to image data is performed on the display panel 40

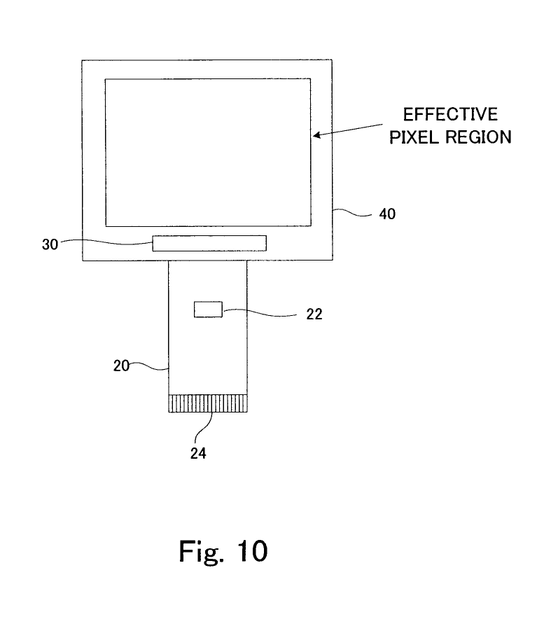

FIG. 10 shows the external view of the flexible cable 20, the driver IC 30, and the display panel 40. As shown, a connection terminal section 24, which is connected to a terminal section provided for the display drive section 10, is formed on one end of the flexible cable 20, and the other end is connected to the driver IC 30 and the display panel 40. The driver IC 30 is mounted on the glass substrate of the display panel 40 as a COG (Chip on Glass). It should be noted that the display panel 40 has a peripheral region around an effective pixel region where pixels are arranged in a matrix state, and the driver IC 30 is mounted on this region. Further, wiring that guides various signals from the mounted driver IC 30 to the effective pixel region is also arranged in the peripheral region.

Further, PVdd for the display panel 40 and the voltage of CV are previously written in the non-volatile memory 22, which is mounted on the flexible cable 20, before shipment from a factory. Values specific to the display panel such as gamma setting and color correction value may be written in the non-volatile memory 22. The micro controller 12 of the display drive section 10 reads the contents of the non-volatile memory 22 when activating the power source of the device, and sets the output voltage (power supply voltage PVdd, CV) of the DC-DC converter 14 to a register 14a inside the DC-DC converter 14. Therefore, the power supply voltage of the display panel 40 is reset every time it is activated to a proper value stored in the non-volatile memory 22.

Next, description will be given for the output voltage of the DC-DC converter 14.

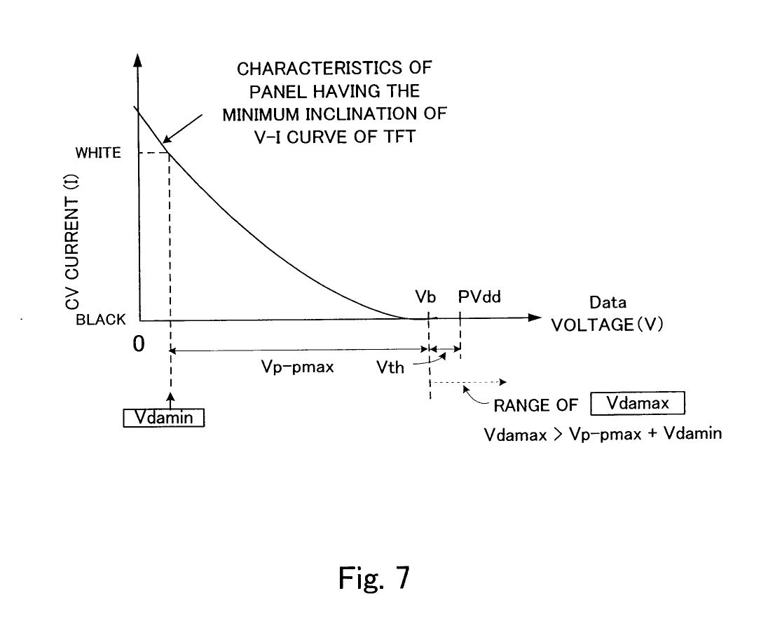

First, the relationship between the maximum output voltage (Vdamax) of the D/A converter 34 of the driver IC 30 and the minimum voltage (Vdamin) that the D/A converter 34 can output, and the maximum value (Vp-pmax) of the dispersion of necessary signal amplitude (FIG. 7) is as shown below.

Vdamax>Vp-pmax+Vdamin [Expression 4]

Herein, Vdamin corresponds to data voltage, where white level current flows, in the characteristic of the display panel having the minimum V-I curve inclination of the TFT. Vdamax corresponds to data voltage Vb, where black level current flows, in the characteristic of the display panel having the minimum V-I curve inclination of the TFT.

Then, the power supply voltage PVdd of the positive side, which is supplied to the display panel 40, is individually adjusted by the value of the threshold voltage Vth for driving TFTs in the display panel 40. In other words, the black level voltage Vb at the output of the D/A converter 34 and the power supply voltage PVdd are adjusted to Vb+Vth=PVdd.

Accordingly, it is assumed that Vdamax in this embodiment has no correlation with the dispersion of Vp-p and Vth, and it can be set lower than Vdamax in the case of using fixed PVdd only by (Vthmax−Vthmin).

Further, in the case where the black level voltage Vb is fixed to a certain value, only the power supply voltage PVdd should be adjusted. At this point, care should be taken to prevent Vb-Vp−pmax from becoming the minimum voltage (Vdamin), which the D/A converter 34 can output, or less.

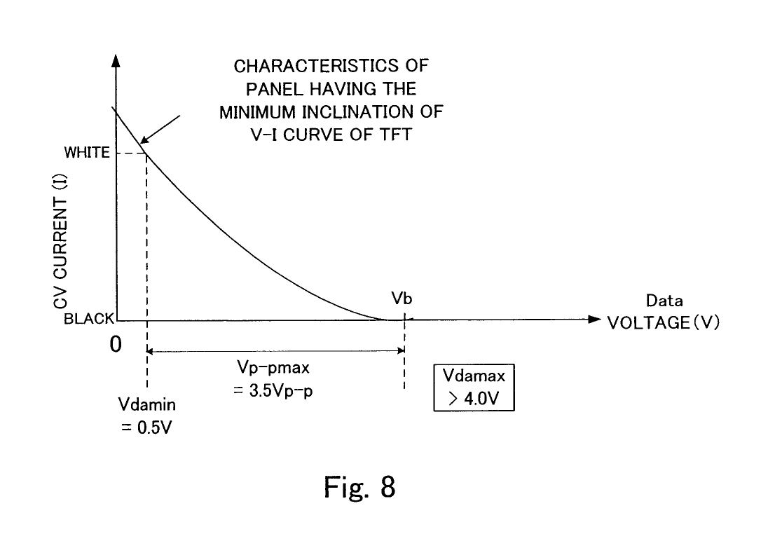

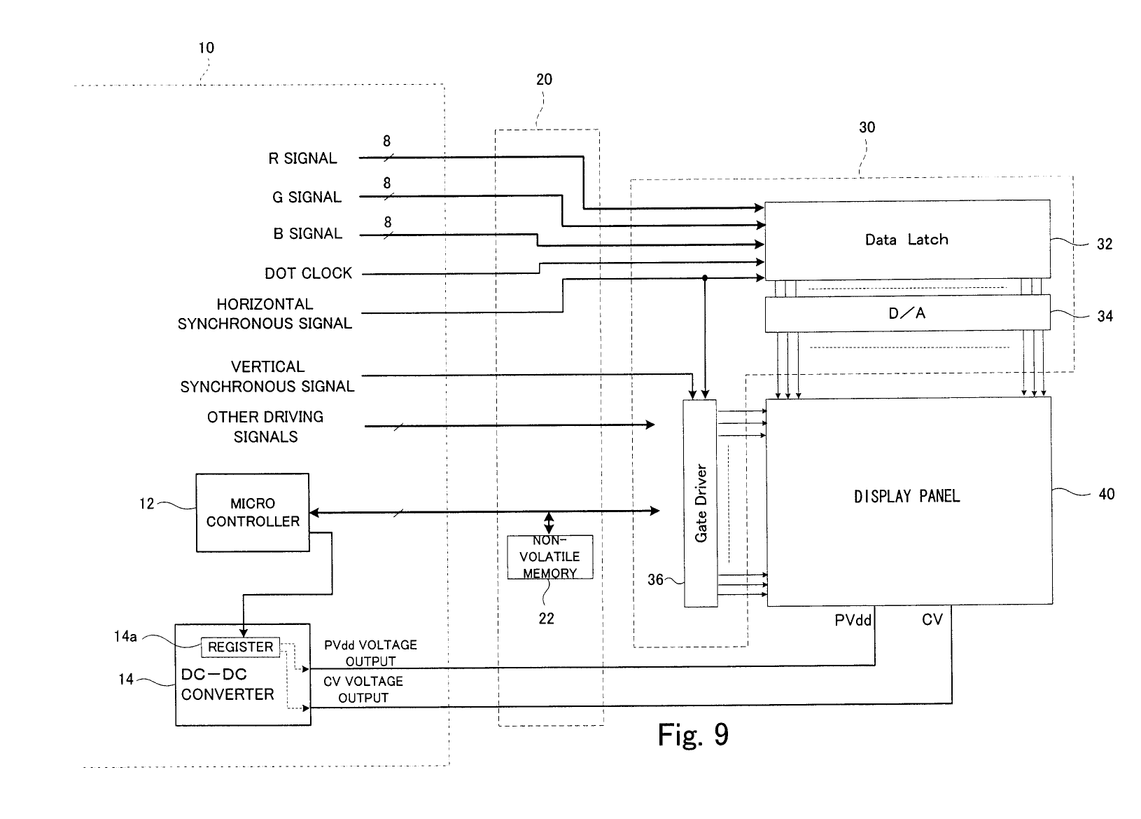

For example, as shown in FIG. 8, assuming that the minimum voltage (Vdamin) of the D/A output is 0.5V and the maximum input signal amplitude required in the display panel having the minimum inclination of the TFT curve is 3.5 Vp-p, the minimum voltage that can be set as the black voltage (Vb) is 4.0V There should be no display panel 40 that requires the black voltage of 4.0V or higher, and therefore the maximum output (Vdamax) of the D/A converter 34 should be 4.0V or higher.

PVdd being the source side power source of the driving TFT is changed in response to the average threshold voltage Vth for driving TFTs in an individual display panel.

For example, in a display panel having Vth of 1.5V, setting should be done as follows.

PVdd=Vb+Vth=4.0V+1.5V=5.5V [Expression 5]

The maximum value of power supply voltage PVdd to be set is determined by the maximum value (Vthmax) of Vth, and becomes Vb+Vthmax.

Herein, the threshold value Vth of the driving TFT in the display panel 40 is a difference Vgs between the gate voltage and the source voltage of a driving TFT, at which the driving TFT turns ON. Then, the power supply voltage PVdd is previously set to a predetermined high voltage, data voltage to be supplied to all pixels is changed, and a voltage value at which current (display panel current) flowing in the entire display panel 40 starts flowing should be measured. Further, the data voltage of all pixels is previously set to a fixed value (black level voltage Vb, for example), the power supply voltage PVdd is changed, and a voltage value at which the display panel current starts flowing may be measured.

As described, in the case where the average Vth can be measured, its value, PVdd corresponding to the value, or the like is written in the non-volatile memory 22. Then, when activating the display device, data in the non-volatile memory 22 is read out into a program that the micro controller 12 executes, a job of setting the output voltage of the DC-DC converter 14 is allocated according to the read-out data, and thus the above-described setting of PVdd based on the average Vth of the driving TFT in the display panel is performed.

Normally, the cathode voltage CV of the organic EL element is set to a value that prevents a pixel driving TFT from coming off a saturation region even when the maximum luminance is outputted. Generally, voltage (PVdd-CV) between PVdd and CV is determined by Vp-p and the characteristic of the organic EL element. Therefore, in the case where the CV voltage is fixed, it is necessary to determine CV in accordance with a display panel having the maximum Vp-p in order to allow pixel driving TFTs to operate in the saturation region on all display panels.

On the other hand, by changing (PVdd-CV) corresponding to Vp-p value of an individual display panel, it is possible to set CV voltage to a required minimum value. For example, for the PVdd value determined in the above-described method, CV should be set as follows assuming that V0 is a fixed value depending on the characteristics of the organic EL element.

CV=PVdd−Vp-p−V0 [Expression 6]

Thus, it is possible to minimize power consumption in each display panel. Further, there is a possibility that Vth will vary when current is allowed to flow in TFTs for a long time. This variation is particularly noticeable in a TFT that uses amorphous silicon (a-Si) as an active layer, and the luminance of the display panel reduces when the display panel is used for a long time due to the increase of Vth. To avoid this, average Vth of the display panel is measured periodically, and it is also possible to adjust PVdd such that black level becomes optimum for Vth at that time.

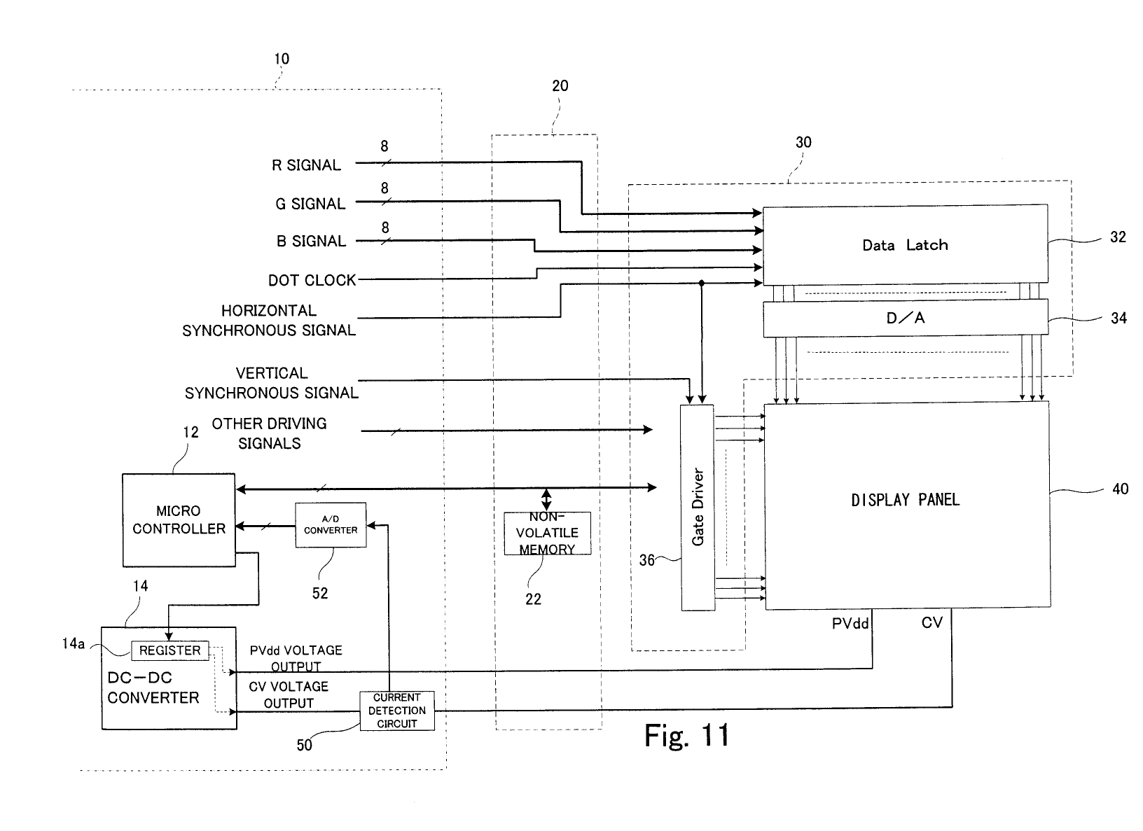

For example, the above-described adjustment can be performed with the constitution as shown in FIG. 11. A current detecting circuit 50 is provided for a connection line between the CV voltage output of the DC-DC converter 14 and the CV end of the display panel 40. This allows the current detecting circuit 50 to detect the total current of the display panel 40. A detection result of the current detecting circuit 50 is supplied to an A/D converter 52, where it is converted into digital data, and supplied to the micro controller 12. The micro controller 12 sets the output voltage of the DC-DC converter 14 in response to the detected current, and the setting is performed as follows.

First, by setting an RGB signal from the display drive section 10 to the black level, voltage Vb is applied to all pixels of the display panel 40. In this state, the value of the power supply voltage PVdd is allowed to vary gradually, and voltage at which display panel current (CV current) starts flowing is detected. The voltage at which the display panel current (CV current) starts flowing is the data voltage giving the black level, and data in the non-volatile memory 22 is rewritten with this value. Further, the data in the non-volatile memory 22 is left unchanged, and its correction data may be held in the non-volatile memory on the display drive section 10 side.

In this embodiment, the current detecting circuit 50 and the A/D converter 52 are provided in the display drive section 10. Therefore, automatic correction to the variation of TFT characteristics on the display panel 40 can be performed in an external device.

According to the present invention, the power supply voltage supplied from the driving power supply to the display panel is changed based on the average threshold voltage value of the driving thin film transistor (TFT) in the display panel. Thus, it is not necessary to consider the dispersion of the threshold voltage Vth of the driving TFT regarding the data voltage to be supplied to each pixel, and therefore the power supply voltage to be supplied to the thin film transistor display panel can be set relatively low.

The invention has been described in detail with particular reference to certain preferred embodiments thereof, but it will be understood that variations and modifications can be effected within the spirit and scope of the invention.

### PARTS LIST

3 organic EL element
10 drive section
12 micro controller
14 DC-DC converter
14a register
20 flexible cable
22 non-volatile memory
24 terminal section
30 driver IC
32 data latch
34 D/A converter
36 gate driver
40 display panel
50 detecting circuit
52 A/D converter

1. An organic EL display device, comprising:
a display panel having pixels arranged in a matrix state, each pixel including an organic EL element and being provided with a driving thin film transistor that corresponds to each organic EL element, and which controls light emission therefrom;
a driving power supply that supplies the display panel with a power supply voltage for driving each organic EL element; and
voltage changing section for changing the power supply voltage supplied from the driving power supply to the display panel based on one or both of average characteristics of the driving thin film transistor and average characteristics of the organic EL element in the display panel.

2. The organic EL display device according to claim 1, wherein the voltage changing section changes the power supply voltage on the source side of the driving thin film transistor based on the average threshold voltage of the driving thin film transistor.

3. The organic EL display device according to claim 1, wherein the voltage changing section changes the voltage of the cathode side of the organic EL element based on necessary signal amplitude and the characteristics of the organic EL element.

4. The organic EL display device according to claim 1, comprising:
a memory that stores the set value of the power supply voltage to be supplied to the display panel, wherein
the voltage changing section reads out the set value from the memory when turning the power source of the display device ON and applies power supply voltage corresponding to the read out set value to the display panel.

5. The organic EL display device according to claim 1, comprising:
measuring section for measuring the average threshold voltage of the driving thin film transistor, wherein
the voltage changing section changes the power supply voltage based on the average threshold voltage measured by the measuring section.

6. The organic EL display device according to claim 5, wherein:
the measuring section includes current detecting section for detecting current flowing in the display panel, and
applies black level displaying voltage to the gate of the thin film transistor, changes the power supply voltage in that state using the voltage changing section, and measures the average threshold voltage based on the detected current in the current detecting section.

7. A method of manufacture an organic EL display device, comprising:
providing a display panel having pixels arranged in a matrix state, each pixel including an organic EL element and being provided with a driving thin film transistor that corresponds to each organic EL element, and which controls light emission therefrom;
measuring the value of the average threshold value voltage of the driving thin film transistor in the manufactured display panel; and
setting power source voltage in the display panel based on the measured average threshold voltage value, necessary signal amplitude, and the characteristics of the organic EL element.
